(19) United States
(12) Patent Application Publication
(10) Pub. No.: US 2008/0136641 A1
(43) Pub. Date: Jun. 12, 2008

(54) Thermal Active Tag for Electronic Designs and Intellectual Property Cores

(75) Inventor: Thomas A. Kean, Edinburgh (GB)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Algotronix, Ltd.

(21) Appl. No.: 11/951,131

(22) Filed: Dec. 5, 2007

(30) Foreign Application Priority Data
Dec. 6, 2006 (GB) 0624364.6

(51) Int. Cl. G08B 13/14; G08B 21/00

(52) U.S. Cl. 340/572.1; 340/584

(57) ABSTRACT

A security tag for electronic designs implemented on integrated circuits uses a thermal transmitter to transmit tag data to an external sensor. The security tag is activated by an activation code sent to the security tag from an external transmitter. The security tag transmits data which indicates the presence of the electronic design to the external detector, for purposes of detecting and preventing unauthorized use of the electronic design. The security tag may use changes in temperature to receive the activation code from the external transmitter, and to send the security tag data to the external sensor. The security tag may use the electronic design associated with the security tag to generate the signals used to transmit the tag data. Alternatively, the security tag may use a dedicated heat generator, such as a collection of ring oscillators, to send these signals. The security tag may use a thermal receiver such as a ring oscillator to receive a thermal signal bearing the activation code from the external transmitter.

This application claims the benefit under 35 U.S.C. 119 of United Kingdom Patent Application GB 0624364.6, titled “Thermal Active Tag for Electronic Designs and Intellectual Property Cores”, filed Dec. 6, 2006.

### FIELD OF THE INVENTION

This invention relates to the labelling and protection of electronic design information used in the creation of integrated circuits and configuration of Field Programmable Gate Array chips. This application is related to the applicant's co-pending UL Patent Application “Method of Actively Tagging Electronic Designs and Intellectual Property Cores” GB 0717347.9, and U.S. patent application Ser. No. 11/852,205, both of which are hereby incorporated by reference herein.

### BACKGROUND OF THE INVENTION

There are several known techniques for identifying the ownership of integrated circuit designs and design fragments, which do not involve the use of active circuits:
1. Copyright and trade secret statements of ownership are conventionally added as ‘comment’ statements to source code files containing design information. These statements claim legal protection for the design source code and function as a deterrent to illegal use.
2. The package of electronic chips is conventionally marked with the name of the company that developed the chip, a product identification code and often a manufacturing date code.
3. Most semiconductor companies also add human readable identification markings, logos and copyright or maskwork ownership statements to the physical chip. This can be done by creating shapes on the top metal layer. In some cases a microscope may be required to read the writing.
4. Watermarking techniques have been proposed where ‘signatures’ created by CAD tools can be detected by analysis of FPGA bitstream files.
5. Several companies offer ‘reverse engineering’ services where they analyse integrated circuit chips to determine the circuits which have been implemented on them. Reverse Engineering services can detect similarities between the maskwork of one integrated circuit and that of another to provide evidence of improper use of an IP core within an integrated circuit. These services are also used for competitive analysis purposes and also to provide evidence of patent infringement.

All of these techniques have important limitations when compared to the active tag disclosed herein:
1. Textual copyright messages added as comments to design source code are easy to remove and are not transferred into the final physical product. Even when watermarking techniques are used to make the copyright messages difficult to detect and remove they are only present in the design source code, not the final product. Therefore, these techniques do not help detect infringement of IP rights in the common practical situation where the only physical evidence available is the final manufactured chip.
2. Markings on the packages of integrated circuits can be removed (for example, by using a solvent) or altered. This could allow, for example, changing the ‘speed grade’ marked on an integrated circuit to make it more valuable. Markings can also be forged—for example a cheap cloned product could be marked as if it came from a more reputable manufacturer to obtain a higher price. Test failures or chips recycled from scrapped products could be marked as if they were newly manufactured.
3. Many contributors to the integrated circuit value chain do not have the ability to mark the package of the final chip product. For example, an IP core vendor supplies a design fragment which is incorporated into the overall chip design but has no involvement with chip manufacturing or packaging.
4. Markings on the integrated circuit chip itself are more robust and harder to alter than markings on the package, however they are also much harder to examine. To do so a suspect chip must often be de-soldered from the equipment it is used in, de-packaged using laboratory equipment and examined under a microscope. This is a time consuming and expensive procedure which destroys the chip and damages the equipment which contained it.
5. Watermarking of FPGA bitstream files can be defeated by making it impossible to access the FPGA bitstream. It is extremely difficult to determine the bitstream used to configure Antifuse and Flash based FPGAs by analysing the programmed device. Modern SRAM based FPGAs provide bitstream encryption circuits which also make accessing the unencrypted bitstream almost impossible. Watermarking techniques are generally less applicable to mask programmed integrated circuits since it would be necessary to depackage and optically examine the mask work to detect the watermark patterns.
6. Reverse engineering services are required to de-package the integrated circuit, and their activities are more labour intensive and therefore expensive than simply looking for a logo or textual message on the chip maskwork.

In contrast to these prior art techniques the ‘active tag’ disclosed in this application can be easily read without damaging the integrated circuit and is both secure and authenticated (that is the data transmitted by the tag cannot be read by unauthorised parties and the tag is resistant to forgery).

An active tag could be viewed as being, in one limited aspect, similar to an RF-ID tag in that it can be sensed at a distance by a receiver. The receiver which detects the active tag is termed a ‘wand’ by analogy with airport security style hand held metal detectors—it is envisaged that a fully developed tag detection receiver will be a small hand held device which may connect to a laptop computer to allow more complex processing.

However, there is at least one significant difference between an RF-ID tag and an active tag: an RF-ID tag is a stand-alone product with an independent power supply whose purpose is to identify another, usually more valuable object. For example, an RF-ID tag would be added to an item of clothing to prevent shoplifting. An active tag on the other hand is a small fragment of the design for a larger chip whose purpose is to identify the chip. The active tag is dependent on the ‘host’ chip to provide services like power supply and sometimes clock and reset signals.

Furthermore, the kind of radio frequency (RF) circuit components such as antennas and inductors that would be used in an RF-ID tag are highly undesirable in an active tag because they are physically large, easy to identify and incompatible with a purely digital implementation. The economics of the active-tag favour use of a very small fraction of the complete chip area, use of very little power and no additional expensive process options.

### SUMMARY OF THE INVENTION

In recent times there has been considerable interest in means of protecting electronic design information from misuse and piracy. The ‘active tag’ technology disclosed here is complementary to prevention or ‘lock on the door’ technologies which use encryption and attempt to prevent IP theft. Instead of trying to prevent misuse of intellectual property the ‘active tag’ seeks to make it easy to detect when it has occurred by identifying the ‘stolen goods’: that is the chips which contain the illegally obtained design information.

As well as detecting design piracy scenarios an ‘active tag’ technology can address misuse scenarios which are outside the scope of other technologies and also provides other potential benefits in the area of market research, system maintenance and diagnosis.

In one novel aspect of an embodiment of this invention an active ‘tag’ circuit is provided whose presence within an integrated circuit or FPGA can easily and cost-effectively be determined. Unlike the tags disclosed in the related patent application GB 0717347.9, instead of operating continuously to send out an identification signal a preferred embodiment of a tag as discussed in this application remains passive until it is activated by a signal from the external wand. This approach has several benefits:
1. The presence of the tag is harder to detect because it does not transmit a signal until commanded to do so by the receiver ‘wand’ which sends a unique secure activation code. Therefore a malicious party cannot detect the tag by listening for its signal.
2. The presence of the wand indicates that the tag is in a safe environment, because the wand is only provided to the owner of the design that the tag is protecting. Therefore, communication from the tag to the wand does not have to be ‘stealthy’ in this scenario.
3. The tag circuit will use less power because it does not have to transmit continuously.
4. Since the activation code sent by the wand is unique to a particular tag the system has no problem with a chip which contains multiple tags—for example, a large System on Chip device may contain tags from IP core vendors as well as a tag to identify the whole chip. Only the tag corresponding to the activation code sent by the wand will be activated.

One disadvantage of this approach, compared with the simpler approach of having the tag transmit continuously, is that some embodiments require both receive and transmit circuits and hence potentially consume more area on the integrated circuit.

In another novel aspect of an embodiment of this invention the tag and wand circuits communicate using a thermal channel, that is by creating and detecting changes in the temperature of the chip. The thermal channel has several benefits in this application:
1. Transmit and Receive circuits are available which require only digital logic to implement. Thus the tag can be used on Field Programmable Gate Arrays and other technologies where only digital logic is available. Moreover, there are no obvious ‘giveaway’ structures such as antennas or spiral inductors which would indicate the presence of an RF transmitter.
2. The thermal channel is difficult to ‘jam’ or disrupt without creating undesirably high power consumption. Attempts to jam communication through the thermal channel would themselves be easy to detect and serve as an indication that something was suspicious about the chip.
3. There is less background noise to contend with than in other potential ‘side’ channels such as the power supply or EMI.

Using the thermal channel of changes in package temperature to transmit information is a novel proposal which has not been developed in the past. A primary disadvantage of the thermal channel is that it is unsuited to transmitting data quickly. However, in this application very few bits need to be sent and even if it takes several minutes or even hours to read a tag this is still a huge step forward from the alternative of microscopic analysis.

Advantages of the ‘active tag’ technology disclosed in this application include:
1. Unlike encryption technologies which protect design information such as source code the ‘active tag’ can detect misuse by parties who have legally acquired the design information. Examples of such misuse are ‘overbuilding’ chips and underpaying royalties and using IP acquired under a single project licence on multiple projects.
2. An ‘active tag’ can be used to detect fake or ‘ghost’ grey market chips which are marked as if they came for a reputable manufacturer but are in fact copies, test failures stolen from scrap bins or recycled from scrapped equipment.
3. The active tag can be programmed to return additional information useful for customer support or product maintenance such as version numbers or error codes from the circuit it protects.
4. The ‘active tag’ can be used by IP core vendors to provide product version information whereas only the company that assembles the complete chip can mark the physical package. Thus, in the event of a product failing in the field an IP vendor can obtain independent confirmation of the version of their IP which was used—and potentially additional status information from the IP.
5. CAD companies can configure design tools to add active tags to the synthesized circuit. For example, tools provided on evaluation or donated under an educational licence might add an active tag so that use to create commercial products could be detected. Similarly a CAD company could detect if a CAD tool licence sold to one company was being used to create designs for many other companies. This might indicate that a ‘pirate’ copy of the tool was in circulation and indicate the original source of pirated software. The CAD tool company could also detect if software sold with a time-limited licence was being used to create chips released after the licence expired.
6. The active tag can be used for market research purposes. For example a CAD tool vendor may be interested in determining the economic value of its tools to a particular company by seeing which products they have been used to design. Similarly, some customers mark chips bought from semiconductor companies with their own logo in order to make it difficult to determine the ‘bill of materials’ for their products and give them more flexibility in changing vendors. The active tag would allow the semiconductor vendor to ‘see through’ chips which have been marked by the customer to determine how their products are being used.

Further objects and advantages of the invention will become apparent from a consideration of the drawings and ensuing description.

### BRIEF DESCRIPTION OF THE DRAWINGS

FIG. 1 shows the basic principle of a remotely activated ‘active tag’ according to an embodiment of the invention.

FIG. 2 shows a more detailed block diagram of an embodiment of an ‘active tag’ receiver.

FIG. 3 shows a block diagram of a thermal tag which operates continuously and uses spread spectrum techniques.

FIG. 4 shows a block diagram of a ring oscillator sampler for use in the thermal tag.

FIG. 5 shows a block diagram of a tag clock generator for use in the thermal tag.

### DETAILED DESCRIPTION OF THE INVENTION

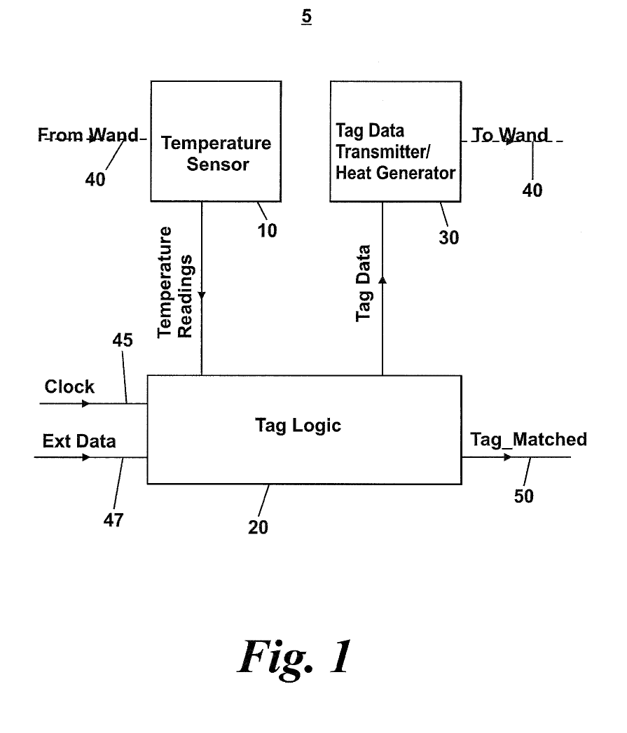

FIG. 1 shows the major functional blocks in the thermal tag 5 of an embodiment of the invention. The functions of the top level blocks are as follows:

The temperature sensor 10 monitors the die temperature of the FPGA or integrated circuit (“IC”) containing the tag and supplies a signal to the tag logic 20 which is sensitive to the die temperature. A wand 40 sends thermal signals to the temperature sensor 10, to provide information such as a secret activation code to the tag logic 20. The tag logic 20 is discussed in further detail below.

The heat generator in the tag data transmitter 30 is activated by the tag logic 20 when it wishes to raise the temperature of the die and hence the external package temperature.

The tag logic 20 receives and demodulates the temperature sensor 10 (e.g. one or more ring oscillators) temperature readings to create a stream of ones and zeros which can be compared with a secret activation code. When this code is detected it activates the trigger signal 50 (i.e. tag_match) and transmits tag data and any external data supplied by the IP core in which the tag is embedded to the wand 40 using the heat generator in the tag data transmitter 30.

Alternatively, in an embodiment, the trigger signal 50 may be used to command another circuit implemented in the IC (e.g. the circuit protected by the tag) to signal to the external world using another method. For example, the protected circuit may simply switch itself off. In this case the presence of the tag would be indicated by the equipment ceasing to function after the wand 40 had transmitted the secret code to the tag 5. Depending on the exact function of the protected circuit a wide range of possible actions to signal the activation of the tag 5 are possible: for example a circuit which decoded an image to display on a video screen could alter the colour information or an audio decoder could produce a continuous tone. In some situations the protected circuit could signal in a very straightforward way by changing the voltage on an external pin. Only authorised parties have access to the wand 40 and the secret activation code. Therefore when the tag circuit 5 has reported that the wand 40 is nearby and has transmitted the secret activation code the tag 5 can assume that it is safe to communicate. It is up to the person using the wand 40 to ensure that there are no malicious parties nearby who could eavesdrop on communication between the tag 5 and the wand 40 and that it is safe to disrupt normal operation of the protected circuit.

An advantage of using the protected circuit to signal the presence of the tag 5 is that the tag 5 no longer needs its own transmitter circuit, such as the heat generator in the tag data transmitter 30, to contact the wand 40 and can therefore be smaller. It is, however, a less flexible approach than having the tag 5 signal back to the wand 40 through the thermal channel (or potentially another side channel, for example power supply noise on a power supply circuit connected to the tag 5).

### Temperature Sensor

It is well known that the speed of integrated circuit chips is affected by temperature—an increase in temperature reduces the speed of operation. The effect can be detected by purely digital circuits, for example, a ring oscillator. The use of ring oscillators to determine on-chip temperature of FPGA chips is discussed in the paper “Thermal Monitoring on FPGAs using Ring Oscillators” by Eduardo Buemo and Sergio Lopez-Buedo in the Proceedings of the FPL97 conference, Springer LNCS 1304, pp 69-78, incorporated by reference herein.

FIG. 1 of the Bueorno and Lopez-Buedo paper shows how a ring oscillator is normally implemented as a sequence of an odd number of inverting logic gates configured with feedback between the first and last gate in the chain. Since each stage of the chain is inverting, if a logic 1 is present at the beginning of the chain once it has propagated through all the gates in the chain and back to the beginning it will have become a 0—and vice versa for a ‘0’ starting at the beginning of the chain. The output of the ring oscillator therefore oscillates between 1 and 0 with a frequency determined by the delay through the inverting gates in the chain. Ring oscillators can be controlled by using a logic gate with two inputs e.g. a NAND gate at one position in the chain—by attaching one terminal of the two input gate to the ‘ring’ signal and the other to an external ‘enable’ signal, oscillation in the chain can be switched on and off by the external enable signal. This is useful because there is power consumption associated with the ring oscillator operation and therefore it is beneficial only to enable it when required.

Since the speed of the logic gates in the ring is affected by temperature, the frequency of the ring oscillator output signal will also be affected by temperature. If it gets hotter then the ring oscillator frequency will be reduced. Thus to build a temperature sensor 10 all that is required is to connect the output of the ring oscillator to a counter 70. The counter 70 can be periodically reset using a clock 72 with a fixed frequency (e.g. a clock derived from a crystal oscillator) and such clocks are generally available in digital logic circuits. The number of pulses from the ring oscillator in a fixed time period derived from the crystal controlled clock will vary according to the current temperature.

The ring oscillator is the presently preferred embodiment of the temperature sensor 10 for use in FPGA chips and chips where only digital circuitry is available. For use in full-custom ASIC chips an attractive alternative embodiment is a temperature sensing diode. Some FPGAs also provide temperature sensing diodes which can be accessed by user designs and could be used by an active tag. A disadvantage of an embodiment using a temperature sensitive diode provided by the FPGA manufacturer is that an attacker with knowledge of the FPGA bitstream format could potentially change a small number of configuration bits to break the connection between the tag and the temperature sensor. Since there is only one temperature sensitive diode on each chip and there may be multiple IP cores, use of a temperature sensor diode provided by the FPGA manufacturer makes more sense in the scenario where the tag is added by the designer of the complete FPGA chip, rather than an IP core vendor.

Other delay sensitive digital circuits apart from ring oscillators could potentially be used as temperature sensors. For example, in an embodiment, a timing path could be set up which completed within one clock cycle if the chip was at a lower temperature but required two clock cycles to complete at a higher temperature. Therefore, while the ring oscillator is currently the preferred embodiment, the invention is not limited to the use of ring oscillators.

The wand circuit in the wand 40 must also sense temperatures in order to detect signaling from the tag. In this case there are two particularly attractive technologies available. Thermocouples can provide very accurate temperature sensing with sensitivities of a fraction of one degree centigrade. However, thermocouples are generally require to be attached directly to the surface whose temperature is to be monitored—in this case the chip package. This is slightly inconvenient although perfectly practical. Other alternative temperature sensitive components such as thermistors could be used instead of thermocouples.

In an embodiment an infra red thermometer is used to provide a non-contact sensor for the wand 40. This is convenient for use in a hand held wand 40 which is held above the chip package. This kind of thermometer measures the frequency of infra red radiation from the surface of interest to determine its temperature—perhaps the best known application of this technology is in hand held electronic fever thermometers which are placed in the patient's ear.

In an embodiment a thermal imaging camera is used to take a picture of the chip package. This image data may provide information about the location of the thermal tag 5 within the chip as well as its temperature.

### Heat Generator

In order to communicate with the wand 40 the tag 5 needs a mechanism to raise the chip's package temperature by a small amount. The thermometer in the wand 40 can be considerably more sensitive and accurate than that in the tag 5 since its implementation is much less constrained. A thermocouple based sensor may be able to detect temperature changes as small as 0.1 degree centigrade—although a signaling scheme may choose to create larger changes to improve robustness.

Generating heat in a silicon chip is not a difficult problem—in fact much attention is paid to reducing chip power consumption and heat generation.

One embodiment of a heat generation circuit in the tag data transmitter 30 comprises multiple ring oscillators. In an embodiment, thirty ring oscillators are enabled for a period of around a second. The ideal number of ring oscillators required and the amount of time for which they must be enabled is dependent on details such as the packaging technology used for the chip, the power consumption of other circuitry on the chip and the sensitivity of the receiver.

Another embodiment of a heat generator in the tag data transmitter 30 connects a high frequency signal to a large capacitive load—for example an FPGA global clock network.

In a preferred embodiment, instead of generating heat itself the tag circuitry 5 requests the circuit which it is protecting to generate additional heat. This approach can save area and make the tag circuit 5 harder to detect. This is particularly suitable when the protected circuit has enhancements such as clock gating to reduce power consumption—it can simply disable these power saving features when requested to generate additional heat.

The external wand 40 also needs a means of generating heat to signal to the on-chip tag. Again, contact and non-contact technologies are available. Thin film heating element ‘patches’ are available which could be stuck to the chip package lid. In an embodiment a customized version of these patches is used which includes a heating element and a thermocouple temperature sensor. Non-contact heating is also easily achieved using a radiant heat source or stream of hot air. One embodiment of the external wand 40 uses a 20 W halogen light bulb controlled by a laptop computer as the heat source—halogen lights generate a large amount of heat as well as visible light.

It is easy for the external wand 40 to create large changes in chip temperature since it can make use of high power heating elements. The ability to use high signaling power makes it very difficult for any ‘on chip’ circuitry to jam the thermal channel from the wand 40 to an on chip tag 5. In general the wand 40 will prefer to signal at lower powers since this can allow higher speed (with a higher power signal a longer cooling time is necessary to allow the package temperature to return to the steady state value before signaling the next bit). In a preferred embodiment the wand 40 attempts to signal at low power and if it receives no response from the on chip tag 5 it gradually increases the power level up to a maximum value chosen to ensure that the chip is not damaged by overheating.

In an embodiment the tag 5 makes use of its own temperature sensor 10 to monitor the amount of heating caused by its heat generator in the tag data transmitter 30 and increases either the level of heat generation (e.g. by increasing the number of heat generating ring oscillators activated) or the time for which heat is generated in order to ensure a sufficient temperature rise is achieved.

In an embodiment the wand 40 makes use of its temperature sensor to monitor the chip package temperature and control the heating element based on the feedback from the temperature sensor so that the desired temperature rise is achieved.

In an embodiment the heat source is simply switched fully on or off and the time for which it is switched on is used to control the temperature rise caused to the chip. In another embodiment both the time and the voltage or current supplied to the heating element are controlled. For example, the heater may be supplied with less than its rated voltage to produce a less intense heating effect.

In an embodiment the wand 40 uses a cooling technology as well as, or instead of a heating technology. A simple cooling technology which could be used is a cooling fan, another alternative is a Peltier cooler. Combining heating and cooling technologies may allow data to be signaled more quickly.

In an embodiment the signaling scheme makes use of multiple temperature levels rather than the simple binary ‘normal temperature’ and ‘heated up’ scheme. For example, the chip temperature could be quantized into cold, normal, hot and very hot levels to provide four possible states and signal two bits of information.

### Operation across a Range of External Clock Signal Frequencies

In most usage scenarios the system containing the tag 5 is not under the control of the tag designer. For example, when the tag 5 is incorporated in an IP core the core is itself included in a larger chip or FPGA design, which the tag designer has no knowledge of or control over. Even if the tag 5 is used to protect a complete chip, the design of the board on which the chip is used is not under the control of the tag designer. There is also a concern that the person responsible for the system which contains the tag 5 may attempt to prevent the tag 5 from operating because they are misusing the intellectual property protected by the tag 5. Therefore the tag 5 needs to be as independent from the surrounding system as possible. The need for independence needs to be traded off against the requirements for low area, low power and avoiding using circuit techniques or chip resources which might make it easier for an attacker to recognize and disable or remove the tag circuit.

In the present design the tag 5 makes use of an asynchronous reset signal and a clock from the surrounding system. Both these signals are readily available in most digital systems and using them does not identify a circuit immediately as being a security tag. If the tag 5 takes clock and reset signals from the circuit it protects it will be difficult to disable the tag 5 by interfering with these signals without also disabling the protected circuit—which will presumably prevent the system from functioning. In systems where the protected component may have its clock turned off for long periods it is possible for the tag 5 to generate its own clock as described below.

There is no absolute requirement for the tag 5 to make use of an external reset signal. Doing so is particularly convenient for simulation during development since it removes unknown or ‘X’ states from the design quickly and reduces simulation time. In an embodiment, instead of using a reset signal from the external circuit the tag 5 uses a counter controlled by a clock source (such as a ring oscillator) and automatically resets itself every time the counter overflows. This would result in the circuit being automatically reset every fixed time period—which might conveniently be one hour. In an embodiment for use on FPGA chips the tag 5 relies on the power on function supplied by the FPGA to initialize critical registers and does not provide another reset mechanism.

In order to sense the ring oscillator based temperature sensor 10 a reference clock 45 is used. One source for this clock 45 is the system containing the FPGA. The exact frequency of the clock 45 supplied by the external system is not known in advance—therefore the tag 5 must be designed to work with a wide range of external clock frequencies. The tag 5 can obtain a rough indication of the external clock frequency by using the clock 72 from the ring oscillator temperature sensor as a ‘physical’ reference. In effect the tag 5 has two clock sources: the ring oscillator clock 72 which is independent of the surrounding system but has a (relatively small) dependence on temperature and the external clock 45 which is determined by the system containing the tag 5 and can have a very wide range of values but which is insensitive to temperature and remains at a stable frequency.

In an embodiment the tag 5 uses multiple ring oscillators of different design: for example with different numbers of inverting elements and with different routing resources connecting the inverting elements. Published research on ring oscillators for monitoring temperature on FPGA chips has shown that there are considerable differences in sensitivity according to the components used. The components used in the ring oscillators affect the relative sensitivity of the ring oscillator to temperature. The goal is to create one ring oscillator for use in the temperature sensor 10 which has significantly greater temperature sensitivity than a second ring oscillator used to create a clock signal for the tag so the tag can operate independent of an external clock. In this case, even though the tag clock also has a degree of temperature sensitivity it can still be used as a reference clock 72 for a ring oscillator based temperature sensor 10. It is not necessary that the tag temperature sensor 10 is completely linear or calibrated against absolute temperature—all that is required to receive signals from the external wand 40 is that it can detect relatively large changes in temperature.

### Operation Across a Range of Die and Ambient Temperatures

The operating temperature of the die containing the tag 5 is dependent on factors outside the control of the tag designer: the system containing the chip, the chip package type and the activity of other functions on the chip. It can, however, be expected that the operating temperature will be largely stable throughout the data transmission to and from the tag 5 (except potentially for a gradual heating caused by the communication itself). Therefore the tag 5 needs to compensate for the ‘steady state’ operating temperature of the chip and should be sensitive to changes in temperature rather than the absolute temperature.

### Operation Across a Range of Signaling Pulse Widths

The external wand 40 will communicate with the tag 5 by raising the temperature of the chip slightly and then allowing it to fall back to the ‘steady state’ value. The exact time period where the on chip tag 5 can detect a raised temperature cannot be predicted entirely accurately from knowledge of how long the external unit enables the signaling heat source since it also depends on environmental factors such as package type. Therefore the tag circuits need to be tolerant to a range of signaling pulse widths.

### Operation Across a Range of Signaling Temperature Pulse Heights

The external wand 40 will communicate with the tag 5 by raising the temperature of the chip slightly and then allowing it to fall back to the ‘steady state’ value. The exact amount by which the on chip temperature will be raised cannot be predicted entirely accurately from knowledge of how long the external unit enables the signaling heat source since it also depends on environmental factors such as package type. Therefore the tag circuits need to be tolerant to a range of signaling pulse heights. The tag 5 needs to detect a ‘significant change in temperature’ rather than an absolute difference in the temperature value.

### Tolerance to Clock Skew Between the Wand and the Tag

The clock used by the wand 40 and that used by the tag 5 are unrelated, therefore they can be expected to be out of phase. The tag circuit needs to synchronise with the communication from the wand 40 and maintain synchronization across the period of data transmission.

### Signaling Waveform

In an embodiment the wand transmitter comprises a 20 W, 12V Halogen bulb placed around 5 cm from the chip containing the tag 5. Halogen bulbs generate a large amount of heat as well as visible light. The goal is to raise the chip package temperature by about 10 degrees Centigrade. Data is signalled by turning a heat source, in this case the halogen bulb, on and off. To signal a ‘1’ the heat source is turned on resulting in increased package temperature, the heat source is left on long enough to ensure that the tag 5 can detect the ‘one’ then it is turned off. At this point the chip package temperature is still raised and falls off with time, assuming the heat source is not reactivated. If the heat source is reactivated then the temperature would increase still further.

In an embodiment a ‘Return to Zero’ RTZ waveform is used. RTZ is an example of a so-called ‘line code’ and the Wikipedia articles on ‘line code’ (http://en.wikipedia.org/wiki/Line_code) and ‘return to zero’ codes (http://en.wikipedia.org/wiki/Return-to-zero) provide useful background information on this topic. As will become apparent self clocking line codes such as return to zero are advantageous in this application.

The logic one consists of a heating period followed by a sufficiently long cooling period for the chip package temperature to approximate the original value. The logic zero comprises the same time period as the logic one without enabling the heat source. This waveform is not optimal for data bandwidth: it would be possible to signal logic 0 in a shorter time period than logic 1. However, this is a good, simple starting point and more complex coding schemes might require more tag circuitry, increasing area, or be more vulnerable to countermeasures.

The basic RTZ waveform provides a means of transmitting 1's and 0's but the tag also needs to determine when to sample the received data stream in order to sample each symbol exactly once and produce a valid sequence of output data.

To allow the tag to ‘lock on’ to the transmitted data a ‘preamble’ is transmitted before the actual data. The preamble consists of a sequence of at least two 1s followed by a single 0. The zero is used to mark the end of the preamble. The tag needs to ‘wake up’ and sample data often enough to ensure that it will detect the preamble—using more ‘1’s in the preamble than are strictly necessary to lock on to the timing will allow the tag to wake up less frequently in the ‘sleep’ phase and thus save power.

After the end of the preamble the transmitter sends a secret ‘tag activation code’ which is known to the tag. When the tag receives the tag code it initiates a response. This might be signalling back to the wand 40 using the thermal channel or carrying out some other action to make its presence known (e.g. disabling the protected circuit). There is a trade-off between using a long secret code to increase security and keeping the code short to minimise transmission time. In the presently preferred embodiment of the tag a 64 bit secret number is used.

In an embodiment the tag makes use of a ‘Morse code’ style signalling waveform where a logic ‘1’ is signalled by enabling the heat source for a relatively long ‘dash’ period and a logic zero by enabling the heat source for a much shorter ‘dot’ period. In standard Morse code the dash period is around three times that of the ‘dot’ period. In standard Morse code numbers and letters of the alphabet are coded up as variable length sequences of dots and dashes—here we are transmitting binary data so there are only two symbols required ‘1’ coded as ‘dash’ and ‘0’ coded as ‘dot’. Periods where the heat source is disabled serve as gaps between ‘dot’ and ‘dash’ symbols and allow for cooling. The particular advantage of this code is that it is insensitive to timing apart from the relative lengths of the ‘dot’ and ‘dash’ symbols. This can allow a relatively simple receiver to successfully decode transmissions with a wide range of timings: for example, the dot period could be 0.2 s and the dash period 0.6 s in a ‘fast’ link for ideal conditions and the dot period could be 1 s and the dash period 3 s for a slow link in difficult conditions.

In an embodiment the tag 5 and wand 40 makes use of a 4b/5b or 8b/10b style line code. These codes are designed to ensure that an equal number of ones and zeros are sent across the communications channel. In the context of a scheme using a heat pulse to signal a logic one this style of code makes sure that there are no long runs of ‘0’ during which the tag 5 or wand circuit 40 may lose synchronisation with the data source. They also prevent a DC offset in the channel which in the context of a thermal signal could equate to a gradually rising package temperature.

Many variants of such line codes are available in the art and could be modified for this purpose. Therefore this invention is not restricted to a particular form of line code. Any line code which serves to make the signal self synchronising or aid clock recovery or which cancels DC offsets may be of benefit in a temperature based signalling scheme. In some embodiments the line code will make use of more than two signalling values for example a four value code could quantise into ‘cold’ ‘normal’ ‘high’ ‘very high’ temperatures or ‘normal’ ‘slightly higher’ ‘higher’ and ‘much higher’ temperatures.

In an embodiment the wand 40 sends the activation signal (secret code signal) and attempts to detect a response from the tag 5. If it does not receive a response it adapts the absolute timings of the transmitted waveform and the intensity of the heat signal and retransmits the signal.

In an embodiment, on correctly decoding the activation signal from the wand 40 the tag 5 transmits its own data to the wand 40 and waits for an acknowledgement to be transmitted from the wand 40. If no acknowledgement is received the tag 5 retransmits its signal at a higher intensity or with different timing parameters.

In an embodiment, on correctly decoding the activation signal from the wand 40 the tag 5 transmits its own response data to the wand 40. If at this point the tag detects that instead of remaining silent the wand is retransmitting the activation code it concludes that the wand did not receive its response signal and has not detected its presence. Therefore, once the full activation code is received again the tag retransmits its response signal at a higher intensity or with different timing parameters.

In an alternative embodiment, the tag demodulation circuits in the tag logic 20 detect the fact that the wand has increased either the power or duration of the signals it is using to communicate with it. The tag logic 20 concludes that it should also increase the power or duration of signals used to communicate from the tag to the wand.

In an embodiment the tag compares the temperature sensor values determined by the temperature sensor 10 in the receiver circuit for use in the quantiser 80 (discussed below) with measurements of temperature changes caused by its own heat generator 30. It then modifies the control signals to the heat generator 30 so that sufficient power is available to allow communication. This calculation can take into account the fact that the receiver in the wand 40 will have superior characteristics to that in the tag 5 and therefore the power level required on the transmitted signal will usually be less than that on the received signal.

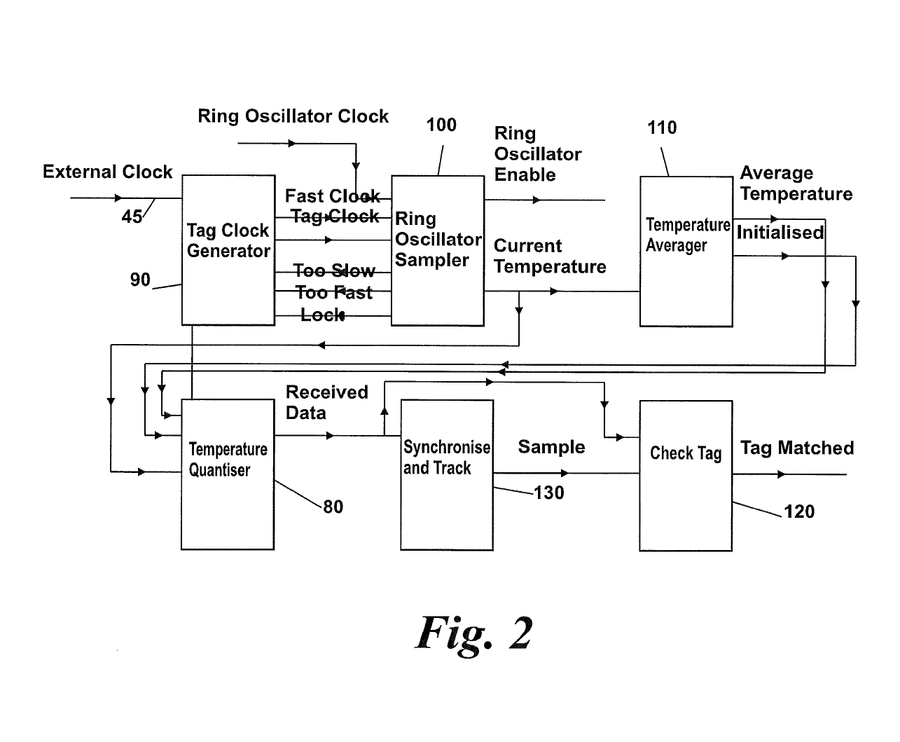

FIG. 2 shows a block diagram of the tag receiver circuitry 20 of a presently preferred embodiment. The function of each of the main circuit blocks in this diagram is now described in more detail.

### Tag Clock Generator

As explained previously, in the preferred embodiment using a ring oscillator temperature sensor the tag circuit will have an external clock signal from the chip containing the tag and an internal clock signal from the ring oscillator available to it. The ring oscillator frequency is subject to some change as chip temperature changes but is largely determined by the layout of the components used in the oscillator (for example number of inverting gates and routing delays between them). Thus, this could be looked on as an inaccurate but tamper resistant clock since it is contained entirely within the tag. The external clock frequency, on the other hand is normally determined from a crystal oscillator and can be viewed as an accurate but vulnerable clock source and one whose frequency is dependent on the system in which the tag is used and may not be known in advance. Therefore, the purpose of the tag clock generator 90 is to take an external clock signal 45 of an unknown frequency and divide it down such that the resulting slower clock is useful to the ring oscillator sampling circuitry 100. In an embodiment the tag clock generator can deal with external clock signals between 20 MHz and 200 MHz.

The tag circuit does not need to determine absolute temperature values in order to demodulate the thermal signal, it must only detect changes in temperature. Similarly, in order to demodulate a self-clocked line code such as an RTZ code it does not need to create a clock frequency of an exact frequency, there is a range of clock frequencies over which the tag will operate correctly. These characteristics simplify the design of the tag clock generator.

Two clocks are produced: the Fast Clock determines the period over which the ring oscillator is sampled and the ‘tag clock’ is the main clock reference for the tag receiver circuit 20.

The ‘fast clock’ must be sufficiently long that the ring oscillator frequency has enough time to stabilise and that the number of ring oscillator pulse counted within this period is a good proxy for temperature. It must be short enough to minimise the power dissipation caused by running the ring oscillator and to minimise the required length of the counter to count ring oscillator pulses. The fast clock must be determined from the external clock since it functions as a fixed reference against which changes in the frequency of the ring oscillator clock caused by temperature changes are determined.

The ring oscillator sampling circuitry can determine whether the ‘fast clock’ provided by the tag clock generator 80 is in the appropriate range to allow a reasonable sampling time for the ring oscillator. For example, in an extreme case, if the counter 70 which counts oscillator pulses overflows during the sampling period the sampling period is clearly too long. Similarly if no pulses are counted it is clearly too short. The ‘too high’ and ‘too low’ thresholds are chosen to ensure that for reasonable temperature swings the counter will not overflow if the temperature falls (making the ring oscillator run faster) or fail to see any pulses if the temperature rises (making the ring oscillator run slower). In an embodiment counter 70 may be 16 bits and a value in the counter after sampling which is lower than 16,384 may be taken as indicating that the fast clock is ‘too fast’ (i.e. its period is not long enough to collect sufficient pulses from the ring oscillator) and a value of more than 49,152 may be taken as indicating the fast clock is ‘too slow’.

When the tag 5 is reset (or powered on for the first time) a stabilising period is required during which the ring oscillator sampling circuit 100 provides feedback to the tag clock generator 90 using the ‘too fast’ and ‘too slow’ signals. The tag clock generator 90 uses this information to correct the division ratio being applied to the external clock 45. This is done quite simply by using a loadable counter to create a programmable clock divider. For example, with a 16 bit loadable counter if the value 0 is loaded the counter will clock 16 times before it overflows and wraps round. If the overflow signal is used as the ‘fast clock’ then its frequency will be 1/16^{th} of the input clock. If, on the other hand, the value 4 is loaded then it will only take (16−4)=12 clock pulses to overflow the loadable counter and the fast clock frequency will be 1/12^{th} of the input clock. In an embodiment the correction mechanism simply increments the value loaded into the loadable counter when the ‘too low’ signal is asserted so that it takes fewer clock pulses to make the loadable counter overflow and the fast clock has a higher frequency. Similarly, when ‘too high’ is asserted the value loaded into the counter is decremented.

Once the sampling circuitry is satisfied with the supplied clock frequency it asserts the ‘lock’ signal and the division ratio (value loaded into the loadable counter) is then fixed. Fixing the division ratio during normal operation ensures that this feedback mechanism only creates a useful clock based on the available external clock and does not respond to changes in chip temperature. When the chip temperature changes the effect will therefore be visible in changes in the number of ring oscillator pulses counted.

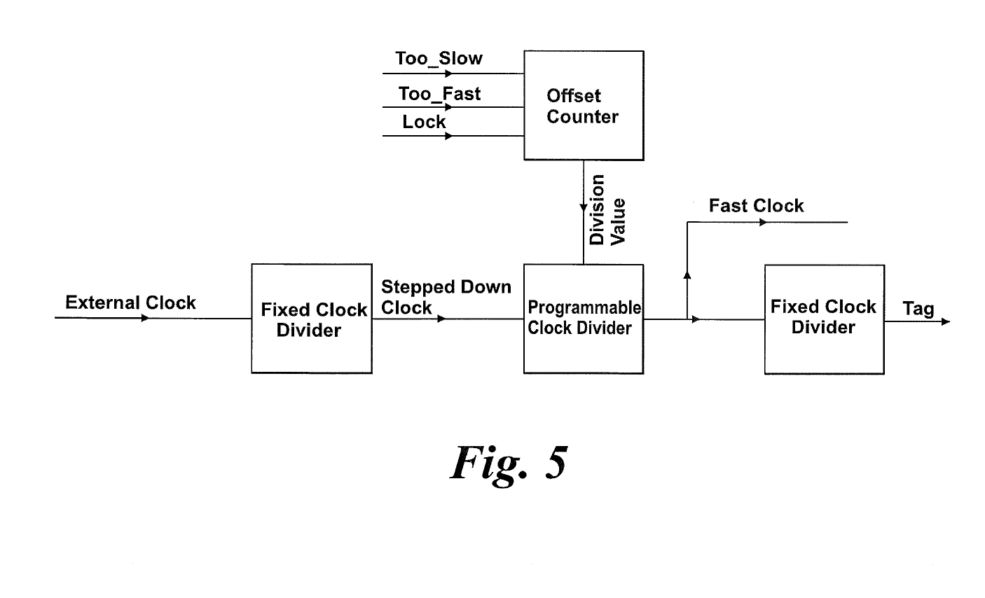

In a preferred embodiment shown in FIG. 5 the clock divider which creates the fast clock from the external clock is composed of a programmable divider built from a loadable counter and a fixed divider built from a standard counter. This design option can be somewhat more area efficient than using a single large loadable counter since the loadable counter requires more area than a standard non-loadable counter—although using a single loadable counter is quite practical. Firstly, a standard non-loadable counter is used to reduce the input clock frequency by a factor based on the minimum external clock frequency divided by an estimate of the required tag clock frequency. For example, in an extreme case, if the minimum input clock frequency was 20 MHz and the rough estimate of the desired fast clock frequency was 2 kHz the fixed counter would be set to divide by 1,000. Preferably, the division ratio is set to a power of two to simplify the implementation—in this case 1024. This would take a 10 stage counter.

The output of the fixed counter is then fed to the loadable counter which compensates for the potential range of external clock frequencies—for example this may be from 20 MHz to 200 MHz corresponding to 2 kHz to 200 kHz. This range can be roughly normalised by dividing by a factor between 1 and 10, which requires only a four bit counter.

The ‘tag clock’ must be sufficiently fast to guarantee that a reasonable number of samples will be taken during the ‘high’ time of the temperature signal. Over sampling is required because the exact waveform of the temperature signal is unknown and subject to variations which the tag needs to be able to detect and compensate for. In an embodiment roughly 8× over sampling is assumed. A lower over sampling ration could potentially reduce tag power consumption. As an indication, in an embodiment of an operating system using the tag, an observation might show that the tag clock frequency was 5 Hz and there were 10 samples taken during the high time of the quantised waveform. The concept of the demodulator is that it uses a self clocked code and automatically adjusts to the waveform it ‘sees’ using feedback mechanisms so there are no ‘correct’ values for tag clock frequency and number of samples during the high time and a subsequent observation might show slightly different values.

### Ring Oscillator Sampler

The ring oscillator sampler 100 uses the tag clock and fast tag clock to create an enable signal for the ring oscillator in the temperature sensor 10 so that the ring oscillator in the temperature sensor 10 does not run continuously burning power.

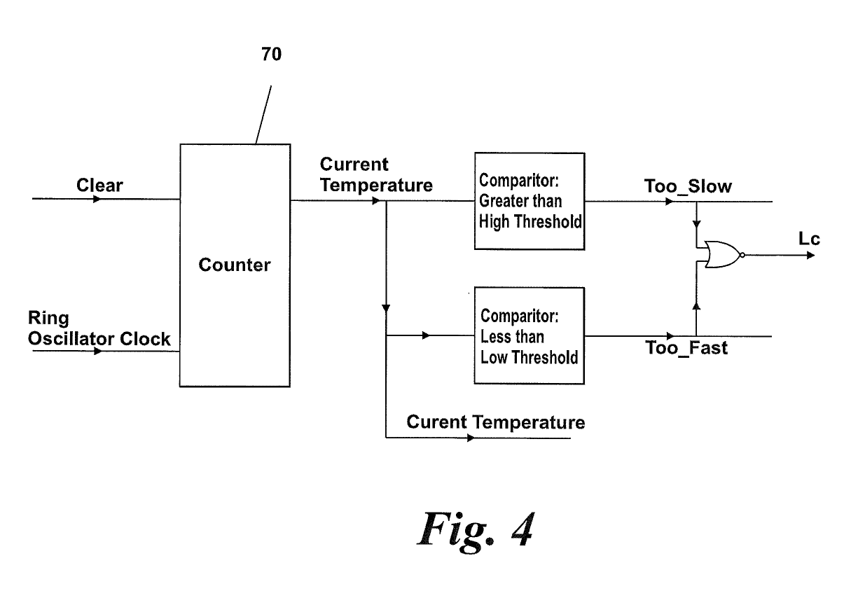

In an embodiment shown in FIG. 4, temperature measurement is carried out immediately following a rising edge on tag clock, at this time the ring oscillator 10 is enabled while the fast tag clock is high and the number of ring oscillator pulses within this period is counted using a 16 bit counter 70. The clear signal to the counter 70 is also brought high briefly immediately following the rising edge of the tag clock so that the count of ring oscillator clock pulses starts from 0. The output of this counter 70 is dependent on the temperature of the device because the ring oscillator clock frequency will be lower at a higher temperature. Thus higher temperatures correspond to lower counts.

As discussed in the previous section, the ring oscillator sampler 100 also determines whether the count is within a desirable range. The count for the ‘steady state’ device temperature needs to be somewhere roughly in the middle of the 0 to 65536 range of possible counts (assuming a 16 bit counter as in the present preferred embodiment), so that when the temperature changes due to signalling or changes in the circuit operating environment the resulting value will still be within the upper and lower bounds. The ‘too fast’ and ‘too slow’ signals are used to provide feedback to the clock generator 90 and the clock frequency is adjusted until it is suitable for measurements. At that point the ring oscillator sampler circuit 100 uses the lock signal to make sure that no further automatic compensation of clock frequency will occur.

In an embodiment, the lower bound below which the ‘too fast’ signal will be asserted is set at 16,384. A simple parallel comparator compares the value in the counter at the end of the sampling period with this constant value and generates the ‘too fast’ signal if it is lower. Similarly, another parallel comparator compares the counter value against the upper bound of 49,152 and sets ‘too slow’ if it is higher. If neither ‘too slow’ or ‘too fast’ are asserted then the ‘lock’ signal is asserted.

### Temperature Statistics (Temperature Averager)

The temperature statistics circuit 110 calculates statistics on the observed temperature (from the temperature sensor 10) over the previous sequence of 64 temperature readings. It provides a ‘background’ number against which to compare the present temperature to determine whether it is significantly higher, corresponding to a logic one. In a presently preferred embodiment the statistics unit calculates the average temperature. The “average temperature” and initialized” signals can be provided to the circuitry on the integrated circuit, to provide status information to this circuitry.

In a currently preferred embodiment the statistics unit 110 calculates the maximum and minimum temperatures measured over the previous sequence of 64 samples. It was observed that the temperature of chips tended to gradually increase for a period of time after they were initially powered on and that temperature sometimes gradually increased due to the signalling activity. Therefore using the minimum temperature over ‘all time’ was found to be less useful than the minimum temperature over the immediately preceding time as a base value to detect changes caused by signalling activity. Similarly, if the maximum temperature over all time was used as a measure of the expected ‘logic one’ value then the system would be vulnerable to an attacker creating a single large temperature pulse to push up the logic one threshold.

There are clearly many possible statistics that could be collected to aid the quantiser 80 in distinguishing signalling symbols. Therefore this invention is not intended to be limited to a particular statistic or quantisation method.

### Quantiser

The quantiser 80 uses the average temperature data from the statistics unit 110 and the current temperature data from the ring oscillator sampler 100 to determine whether the current temperature corresponds to a logic 1 or a logic 0. In some embodiments the quantiser 80 will distinguish between more than two potential logic values.

In the present preferred embodiment there are two signalling values—logic 1 and logic 0 and the logic threshold is set using the minimum and maximum temperatures detected within the previous 64 samples. In an embodiment, the threshold is the minimum temperature plus a quarter of the difference between the maximum and minimum temperatures. In an embodiment the ‘temperature’ values are 16 bit numbers representing the number of pulses from the ring oscillator within the fixed period: in this case higher values will correspond to lower temperatures. In an embodiment, the quantiser functions by simply comparing the actual temperature against the threshold and outputting a ‘1’ if it is less (i.e. higher temperature) or a ‘0’ if it is more (lower temperature).

There are clearly many other choices that could be made and this invention is not intended to be limited to one particular quantisation method.

### Synchronise and Track

As was previously discussed there are many possible ‘line codes’ which may be applied to the temperature waveform. Different schemes would be required to demodulate the different line codes. This is an established area of art in communications systems design and these codes have been widely applied to radio, optical and electrical waveforms. An embodiment of the invention uses temperature changes to signal information through a chip package. The specific line code chosen and the demodulation circuits used are design choices for those of skill in the art, dependent on which line code is used, and are not critical to embodiments of the invention. This application involves very low data rates (64 bits in perhaps as much as 5 minutes) but must use a very small number of logic resources (since the customer will not be willing to devote significant chip area to a security tag), therefore the implementation is kept very simple. The Wikipedia articles on ‘line code’ (http://en.wikipedia.org/wiki/Line_code) and ‘return to zero’ codes (http://en.wikipedia.org/wiki/Return-to-zero) provide useful background information on this topic. Self clocking line codes such as return to zero are considered advantageous in this application.

In the present preferred embodiment the synchronise and track circuit 120 operates in three basic conditions: waiting for the preamble, processing the preamble to determine basic timing on the signal waveform and sampling data.

Preambles are commonly used in communications systems to help with initial synchronisation between transmitter and receiver and quantification of the channel: the preamble is a fixed sequence of bits which is known in advance to the receiver. In an embodiment the preamble is the code “1111110”. As previously discussed, in an embodiment a Return to Zero (RTZ) waveform is used where a logic 1 corresponds to heating the chip for a period of time then switching off the heat source for a second period to allow the chip to cool down towards the ‘base’ value of temperature. A logic 0 corresponds to the same overall time period without the heat source being turned on. The single logic 0 at the end of the preamble serves as an indication that the preamble is completed.

In an embodiment, during the preamble phase two basic timing parameters are calculated:
1. The number of ‘tag clocks’ for which the input data is high—this measures the ‘width’ of the heating pulse during logic 1.
2. The number of ‘tag clocks’ between the input data going low following a valid high and going high again for the next logic 1 in the preamble sequence—when added to the value determined in step 1 this corresponds to a complete symbol time.

If these values are approximately the same twice running then the circuit 120 has locked on to the preamble (“11111110”) and acquired sufficient timing information to allow it to demodulate the data stream. It is expected that the time for the chip to ‘heat up’ when a logic 1 is transmitted will be different from (and usually faster than) the time for the chip to ‘cool down’ to the base temperature when the heat source is turned off.

The intention is to sample data ‘in the middle’ of the time period when the waveform would be high if a logic one was being transmitted. Sampling is done by a counter, the counter counts clock pulses and generates a sample pulse every low_time+high_time pulses. The counter is initialised on the trailing edge of a high pulse with the value high_time/2, this offset puts the next sample pulse in the middle of, rather than the trailing edge of the high waveform.

Since neither the phase or the frequency of the tag clock used to sample the input data is guaranteed to be an exact integer fraction of the clock used by the external circuit to generate the heat signal there will be an error in the sampling process. This error will accumulate across the data sequence and the sampling pulse will gradually move away from the centre of the input data. To correct for this, each time a ‘1’ is sampled the circuit 120 determines whether the sample pulse is to the left or the right of the centre of the input data waveform and issues a one clock cycle correction to the counter which determines the next sample point. This control loop will keep the sampling process synchronised provided there are sufficient ‘1’s in the input data stream. There may need to be rules about the number of ‘1’s in the secret tag values to be transmitted or some simple line-coding may be required to add additional ‘1’s after a long sequence of zeros. Since the maximum data length to be transmitted is 64 bits in the present preferred embodiment there is limited opportunity for error accumulation and avoiding the use of activation codes with long strings of 0 or 1 bits is presently preferred to the use of line coding.

### Check Tag

The check tag circuit 130 uses the sample pulse generated by the synchronise and track circuit 120 and the quantised data from the quantiser 80. The value of the quantised data at the point in time where the sample pulse is high represents a received ‘1’ or ‘0’ bit. This stream of 1s and 0s is compared in turn with the expected value at the corresponding bit position of the secret tag activation code (which is stored in a small memory, not shown) and the tag_match signal is asserted if there is a match after the complete sequence of data has been demodulated. In an embodiment the tag's activity is complete after the tag_match signal is activated, the larger system protected by the tag then takes appropriate action (for example, it might shut itself down) so that the person applying the tag code to the chip using the wand can see an obvious change in behaviour. In an alternative embodiment the tag contains additional Tag Data Transmitter circuitry to signal back to the wand using a heat generator on the chip.

Checking the tag against the expected value can be done very simply using a serial to parallel register to create a word representing the last set of bits received by the tag (64 bit word for a 64 bit tag) and a 64 bit comparator to compare this against the fixed expected value and generate the tag_match signal.

### Tag Data Transmitter

The present preferred embodiment of the tag data transmitter circuit 140 comprises a heat generator such as the heat generator in the tag data transmitter 30 discussed above, a memory containing data to be transmitted and timing circuits.

The heat generator in the tag data transmitter 30 comprises thirty of the same gated ring oscillator elements used as temperature sensors 10. This design of the heat generator in the tag data transmitter 30 was chosen simply for convenience and has proved effective. There are many possible designs for heat generators in the tag data transmitter 30 and this invention is not intended to be limited to this particular example.

The memory containing data to be transmitted is a simple Read Only Memory (ROM). Rather than design additional circuitry to create a preamble signal the preamble data was simply added to the data memory.

The timing circuitry uses the tag clock signal derived in the receiver circuit. It uses a return to zero signalling scheme and divides each signalling period into 16 clock cycles. A logic one is transmitted as 8 clock cycles with the heat generator 30 enabled followed by 8 clock cycles with the heat generator in the tag data transmitter 30 disabled. A logic zero is transmitted as 16 clock cycles with the heat generator in the tag data transmitter 30 disabled.

In an embodiment, the tag 5 will transmit external data 47 (shown in FIG. 1) obtained from the circuit it is protecting as well as or instead of fixed data from a ROM. This could include status or fault information.

In an embodiment the tag contains a ROM built using antifuses, flash memory or a similar non-volatile technology which can be programmed in the field or during chip testing or assembly.

In an embodiment information is added to the tag memory during product test or assembly and is specific to a particular chip rather than common for every chip with the same design. This information could include the date of manufacture, serial number, customer identification, target geographical market, speed grade as determined by testing and test outcome.

### Covert Tag Data Transmitter

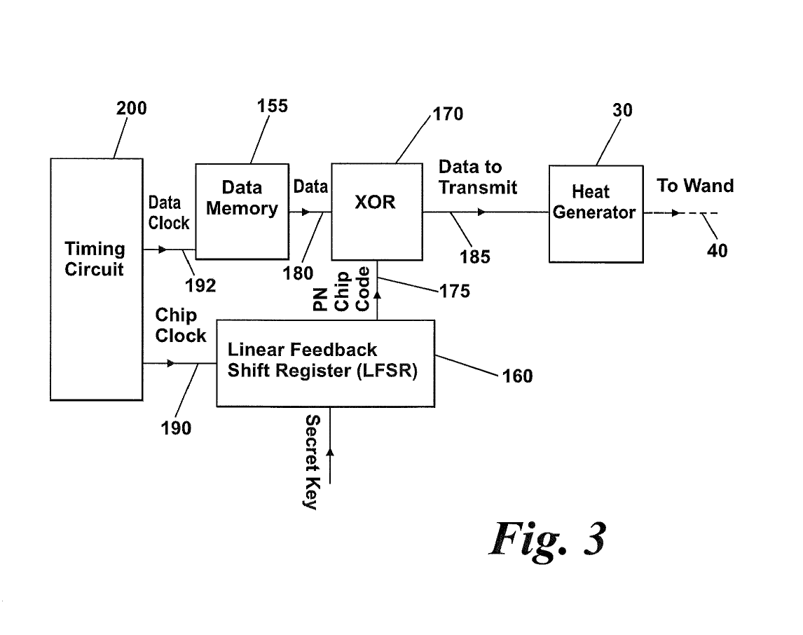

In a currently preferred embodiment as shown in FIG. 3, an alternative embodiment of a thermal active tag according to this invention the tag does not contain activation circuitry responsive to transmissions from the wand 40. Instead, the tag data transmitter 150 is run continuously. Since no receiving circuitry is required this form of the active tag is simpler and requires less area than embodiments which are activated by the wand 40. Conversely, because the data transmission circuitry runs continuously power consumption is likely to be higher. Also, since the data transmission is continuous it could potentially be monitored by a malicious party and therefore it is desirable that the data transmission is covert and difficult to detect without secret knowledge which is only available to authorised parties. Moreover, since there could be several tag circuits in a large System on Chip integrated circuit all of which transmit continuously it is desirable that the individual transmissions can still be received successfully despite interference from multiple transmitters. It is also desirable that the tag transmitter is robust in the face of intentional jamming and that this is achieved without using high power transmissions.

In the field of military communications and more recently in cellular phone systems a coding technique called Code Division Multiple Access (CDMA) has been employed. In this technique data to be transmitted is encoded using a so called ‘spreading code’. The spreading code multiplies the number of coded bits transmitted for each data bit—for example 64 bits may be transmitted for each data bit. In this case the ‘chip’ rate is said to be 64 times the data rate. This has the effect of increasing the bandwidth of the transmission channel required or ‘spreading’ the spectrum of the transmitted signal. While it is generally undesirable to increase the bandwidth required to transmit a given signal the CDMA technique has several advantages:
1. Multiple transmitters can share the same ‘channel’ of RF spectrum and provided they are given unique spreading codes the receiver circuit can still successfully extract each individual signal.
2. From the point of view of an eavesdropper who has no knowledge of the spreading code the transmitted data appears like ‘noise’. It can be made difficult for an attacker to even detect that communication is taking place.
3. The signal is resistant to jamming.

The signal can be transmitted at lower power due to ‘coding gain’ in the receiver.

In an embodiment the tag applies a CDMA spreading code to data being transmitted through the thermal channel 30 to the wand 40.

In an embodiment, the CDMA code (such as a Walsh code) is applied to the data before it is stored in a ROM 155 within the tag 5 so that the tag does not need to contain CDMA coding circuitry but simply provides a larger ROM memory 155 than would otherwise be required.

In the context of the thermal channel the effect of increasing the number of bits to be transmitted by using a spreading code is likely to be an increase in the time needed to transmit the data.

In the field of cryptography considerable interest has been devoted to ‘stream ciphers’ based on linear feedback shift registers (LFSR) 160. These LFSRs are parameterised using a relatively short key 165 and create a very long stream of essentially random (pseudo-random) binary numbers 175. This stream of random numbers can be XOR'd 170 to encrypt a stream of data 180 and the resulting encrypted stream 185 appears like random noise to someone who does not have knowledge of the key 165 used to parameterise the LFSR. However, with knowledge of the key 165 the encrypted data 185 can be decrypted using the same LFSR in the receiver (such as the wand 40) and XOR'ing its output with the encrypted data. This works because XOR'ing a binary digit with the same value twice results in the original binary digit.

In an embodiment, father than applying one bit of LFSR output 175 to one bit of data to be encrypted 180 the LFSR 160 is operated at higher ‘chip’ clock rate 190 than the data to be encrypted 192. These clocks are provided by a timing circuit 200, which could be the tag clock generator 90 discussed above, or a timing circuit found on the FPGA or IC containing the tag. For example, the LFSR 160 might be clocked 64 times faster than the data to be encrypted. In this configuration the random data output 175 from the LFSR 160 function as a spreading code. The advantage of using the LFSR 160 as the spreading code generator is that it provides extra security by encrypting the data as well as spreading it. Standard CDMA spreading codes repeat relatively often where an LFSR can be designed to have an extremely long period before the code pattern repeats. This makes it almost impossible for an attacker to use brute force techniques to discover or decrypt the data communication. An LFSR can be implemented very easily in digital logic and requires little chip area.

In an alternative embodiment the LFSR 160 is operated at the same data rate as the data to be transmitted and a conventional CDMA spreading code is applied to the resulting encrypted data stream.

In a preferred embodiment the power level and bit transmission time of the spread spectrum signal is chosen so that the resulting changes in the chip package temperature are indistinguishable from thermal noise to anyone without knowledge of the spreading code.

### Novel Usage of the Active Tag

The active tag circuit enables several novel usage scenarios which cannot be addressed by prior-art identification technologies.

In a method according to this invention this chip specific information communicated by the active tag is used to detect mislabelling of the chip product including recycling of old chips, alteration of speed grades and passing off test failures, partially tested or partially functional devices as meeting a full specification.

In a method according to this invention the customer identification information from the tag is used to detect diversion of chips supplied to one customer under preferential conditions to another customer or the general market.

In a method according to this invention the geographical market information is used to detect chips which are supplied on preferential terms to customers in a particular geographical market being redirected to another geographical market.

In a method according to this invention the additional information stored in the ROM is used to detect chips which are specified only for use in particular geographic markets being diverted outside those markets. For example, the chips may include circuits which might violate patents in some countries or which require particular testing or qualification procedures in some countries for safety reasons.

In a method according to this invention the tag is added automatically to a user design by CAD tools and identifies the software used to create the design. In an embodiment this information includes details useful in detecting breaches of the CAD software licence agreement.

1. A security tag for an electronic design implemented on an integrated circuit, comprising:
Tag data which uniquely identifies the electronic design;
a receiver for receiving an activation code from a remote transmitter; and
A transmitter for transmitting the tag data using a tag data signal to an external detector, in response to the received activation code.

2. The security tag of claim 1, wherein the receiver comprises a temperature sensor.

3. The security tag of claim 2, wherein the temperature sensor comprises a ring oscillator.

4. The security tag of claim 2, wherein the temperature sensor comprises a diode.

5. The security tag of claim 1, wherein the transmitter comprises a heat generator.

6. The security tag of claim 4, wherein the transmitter comprises a plurality of ring oscillators.

7. The security tag of claim 1, wherein the activation code is unique to the security tag.

8. The security tag of claim 1, wherein the receiver and the transmitter consist of digital logic.

9. The security tag of claim 1, wherein the tag data further comprises data from the electronic design implemented on the integrated circuit.

10. The security tag of claim 9, wherein the tag data comprises error information.

11. The security tag of claim 1, wherein the tag data further comprises design tool information, identifying a design tool used to create the electronic design.

12. The security tag of claim 1, wherein the transmitter comprises the electronic design.

13. The security tag of claim 12, wherein the activation code is unique to the security tag, wherein the electronic design performs a function in response to the received activation code, and the performed function causes the tag data to be transmitted, further wherein the tag data comprises a detectable result of performance of the function, in response to the unique activation code.

14. The security tag of claim 13, wherein the function comprises deactivation of the electronic design.

15. The security tag of claim 1, wherein the security tag is controlled by an asynchronous reset signal and a clock signal, both supplied by the electronic design.

16. A security tag for an electronic design implemented on an integrated circuit, the integrated circuit comprising a chip package, comprising:
A temperature sensor for receiving information transmitted thermally through the chip package.

17. A security tag for an electronic design implemented on an integrated circuit, the integrated circuit comprising a chip package, comprising:
a heat generator for transmitting information thermally through the chip package to an external detector.

18. The security tag of claim 17, wherein the information comprises tag data that uniquely identifies the electronic design.

19. The security tag of claim 17, wherein the information comprises design tool information, identifying a design tool used to create the electronic design

20. A method for identifying a CAD tool used to create an electronic design for an integrated circuit, comprising:
Receiving the integrated circuit, the integrated circuit having a security tag added to the electronic design on the integrated circuit by a CAD tool used to create the electronic design;
Detecting the presence of the security tag within the integrated circuit, while the integrated circuit is operating.

21. The method of claim 20, wherein detecting the presence of the security tag comprises receiving tag data information from the security tag, which tag data information uniquely identifies the CAD tool.

22. A method for identifying a falsely labelled integrated circuit, comprising:
Receiving an integrated circuit, the integrated circuit comprising an electronic design and a chip package, the chip package comprising a label identifying the electronic design;
Using a detector to detect a security tag within the integrated circuit, while the integrated circuit is operating;
Comparing the detected security tag with the label; and
Determining based on the comparison whether the label falsely identifies the electronic design.

23. The method of claim 22, wherein the detector detects a thermal emission from the integrated circuit, the thermal emission comprising tag data identifying the electronic design.
